(19) United States
(12) Patent Application Publication
(10) Pub. No.: US 2025/0347978 A1
(43) Pub. Date: Nov. 13, 2025

(54) LIQUID LENS SHUTTER SYNCHRONIZATION FOR OPTICAL PROFILOMETRY

(71) Applicant: Perceptron, Inc., Plymouth, MI (US)

(72) Inventors: Thomas Erickson, Canton, MI (US); Claire Gardner, Livonia, MI (US)

(21) Appl. No.: 18/661,068

(22) Filed: May 10, 2024

(51) Int. Cl. G03B 7/20; G01S 17/86; G01S 17/89; G03B 9/28; G03B 9/70

(52) U.S. Cl. CPC G03B 7/20; G01S 17/86; G01S 17/89; G03B 9/28; G03B 9/70

(57) ABSTRACT

An optical sensor system comprises a rolling shutter camera, a laser, and a liquid lens placed in a path of the laser, wherein the liquid lens is synchronized to the camera. A related method for synchronized optical profilometry comprises providing a camera, providing a laser beam source, providing a liquid lens, and synchronizing the liquid lens to the camera. A computer program product is also provided.

### FIELD OF TECHNOLOGY

The present invention relates to optical systems, for example, systems for optical profilometry and related methods. The optical systems may use a liquid lens to move a laser beam waist rapidly with precision.

### BACKGROUND

Optical profilometry, for example, with triangulation, is used in a wide variety of applications. A basic principle involves correlating an appearance of a laser plane in a camera's field of view with its location in real space. Accurate and repeatable measurement relies on how tightly a laser line position can be determined by the camera.

Thus, systems and methods for providing improved laser line position and more precise optical profilometry would be well received in the art.

### SUMMARY

An embodiment of the present invention relates to an optical sensor system comprising a rolling shutter camera, a laser, and a liquid lens placed in a path of the laser, wherein the liquid lens is synchronized to the rolling shutter camera.

A further embodiment of the present invention relates to a method for synchronized optical profilometry, comprising providing a camera, providing a laser beam source, providing a liquid lens, and synchronizing the liquid lens to the camera.

A further embodiment of the present invention relates to a computer program product comprising a computer readable hardware storage medium having program instructions embodied therewith, the program instructions readable by one or more processors of a computer system to cause the one or more processors to: synchronize a liquid lens to a rolling shutter camera.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1A depicts a schematic of a general configuration of an optical system according to embodiments;

FIG. 1B depicts another schematic of a further general configuration of the optical system according to embodiments;

FIG. 2 depicts a schematic of an optical system using a Scheimpflug configuration according to further embodiments;

FIG. 3 depicts a general schematic of a Scheimpflug configuration according to embodiments;

FIG. 4 depicts a comparison of pixel collection for a rolling shutter camera compared to a global shutter camera;

FIG. 5 is a graph of comparative data gathered using an optical system with and without synchronizing according to embodiments;

FIG. 6A depicts a schematic model of a liquid lens in a first configuration according to embodiments;

FIG. 6B depicts a schematic model of the liquid lens of FIG. 6A in a second configuration according to embodiments;

FIG. 7 depicts a flow chart of a method according to embodiments;

FIG. 8 depicts a flow chart of a further method according to embodiments;

FIG. 9 depicts a computing environment which contains an example of an environment for the execution of at least some of the computer code involved in performing the inventive methods, in accordance with embodiments of the present invention;

FIG. 10A depicts measurement of a corner without embodiments of the present invention; and

FIG. 10B depicts measurement of a corner using embodiments of the present invention.

### DETAILED DESCRIPTION

As discussed above, a basic principle in optical profilometry is correlating the appearance of a laser plane in a camera's field of view with its location in real space. This relies on known positioning of the camera and either the laser or a second camera. Accurate and repeatable measurement also relies on how tightly the laser line position can be determined by the camera. There are a variety of factors limiting this position detection, including camera resolution, lens sharpness, and laser speckle. Apparent laser position can also be limited by the laser spot width, which is usually in turn limited by gaussian wave propagation. A smaller spot can be achieved at a laser beam waist with a wider divergence angle, but results in a much larger spot further away from the laser beam waist.

If a depth of field is known, a compromise can be made to find a laser beam width that provides the narrowest spot of the laser beam over the entire region. Alternatively, if an exact depth is known, the laser beam focus can be set for exactly the location being examined. In embodiments, this could be done with a static laser focus, for a single application, or done dynamically with a variable lens. However, the depth may not be known, or a subject of interest might exist across a range of depths, and the compromise spot size may be too large to resolve the desired features.

In embodiments, a liquid lens may be used. Liquid lenses offer the ability to move the laser beam waist rapidly with precision. Further, liquid lenses are durable and resistant to mechanical shock and orientation changes, compared to conventional variable-focus lenses. Liquid lenses may also allow imaging of the laser below the size achieved with static optics.

Turning now to the camera, in embodiments the camera may comprise a rolling shutter camera, a global shutter camera, or other type of camera. Rolling shutter cameras are often seen as more limited than global shutter cameras, for example, because of distortions when imaging moving scenes.

However, in embodiments, the rolling shutter camera may be used, and the disadvantages avoided, by imaging a changing laser beam at only an ideal time and place as discussed in more detail below. For example, as specific pixels are gathering light in image space, the location being seen in object space is similarly moving. Embodiments of the invention are directed to providing a laser at these pixels and in a synchronized manner.

While some embodiments thus may be directed to using the rolling shutter camera and avoiding disadvantages thereof, this application and embodiments are not limited to such a camera. For example, embodiments also may use a global shutter camera or other type of camera and may synchronize the liquid lens to the camera, for example, to a region of interest of the camera.

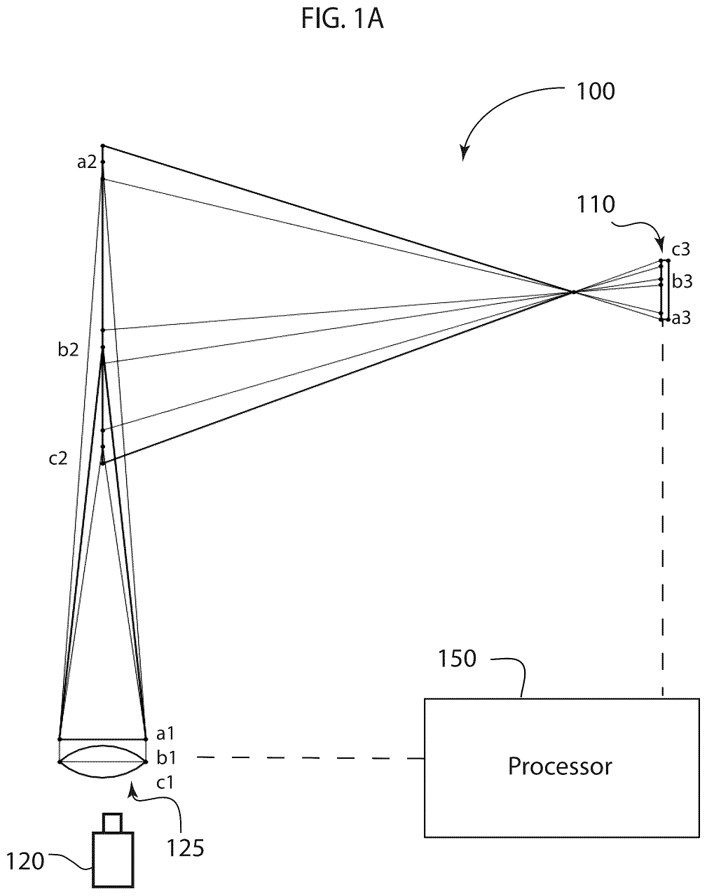

Referring now to FIG. 1A, a general configuration of an optical system 100 is shown in schematic form according to embodiments. The optical system 100 may also be referred to as a sensor system in embodiments. The optical system 100 or sensor system comprises a camera 110, for example, a global shutter camera using multiple regions of interest and/or a rolling shutter camera with a pixel exposure that changes over the exposure time. The optical system 100 also comprises a laser 120 for emitting a laser beam. Further, the optical system comprises a liquid lens 125. For example, the liquid lens 125 is placed in the path of the laser beam emitted by the laser 120. The liquid lens 125 is configured for variable settings. For example, a shape of the liquid lens 125 may be varied, i.e., the liquid lens 125 may have a shape that is changed or driven by a lens driver, at a1, b1 and c1. The variation in shape is discussed in more detail below.

FIG. 1A depicts a change in the shape of the liquid lens 125 at three different settings and respective times, for example, a1, b1, and c1. These settings lead to respective laser beam waist points of the laser beam emitted by the laser 120, for example, at a2, b2, and c2. Further, these respective times correspond to when the camera 110 is gathering light at different positions and/or regions of interest a3, b3, and c3 respectively according to embodiments. For example, positions a3, b3, and c3, may represent which region of interest of an imager of the camera is/are gathering light and/or which pixel(s) or pixel row(s) of an imager of the camera is/are gathering light.

In embodiments, a Scheimpflug configuration can be used for an ideal test condition. For example, by tilting the image plane relative to the lens, the object plane is also tilted. This can result in the object plane overlapping with the laser beam throughout an entire length. The Scheimpflug configuration brings the entire laser beam into sharp focus on the camera end, eliminating limitations from depth of field of the camera. The Scheimpflug configuration also brings into sharp contrast the need for a smaller laser spot.

Thus, as can be seen in the exemplary schematic of FIG. 1A, the liquid lens 125, or settings thereof, may be altered to provide a laser beam waist of the laser beam emitted by the laser 120 substantially at the respective location currently being imaged by the camera 110, for example, a region of interest being imaged by a global shutter and/or a location being imaged by the camera 110 as the rolling shutter camera proceeds through an imaging sequence, along pixel rows, or the like.

Still further, in some embodiments, the optical system 100 may further comprise a second camera, for example, second camera 111 as shown in FIG. 1B. As shown, the second camera 111 may be provided on the opposite side of the laser 120. Thus, the second camera 111 may provide a known position as part of a triangulation process to accurately and reliably determine the position of the laser spot or laser line. In embodiments, the second camera 111 may be synchronized with the camera 110 and liquid lens 125. This could be achieved by varying the readout speed of the second camera 111, matching the fields of view of the respective cameras, or using a different speed of camera. Multiple global shutter cameras could likewise be synchronized by triggering each region of interest at the same time. Alternatively, separate liquid lens sweeps and exposures for each camera could be used, allowing for independent operation. The use of two or more cameras may improve accuracy, reduce reliance on laser line stability, and allow viewing of surfaces at multiple angles.

As will be discussed in more detail, the liquid lens 125 may be synchronized to the camera 110. In embodiments, the optical system 100 may comprise, or may be in communication with, a processor 150, for example, a processor of a computing system, for synchronizing. The schematic of FIG. 1A depicts the processor 150 as separate from, and connected to, the liquid lens 125 and the camera 110, while the schematic of FIG. 1B depicts the processor 150 as separate from, and connected to, the liquid lens 125, camera 110, and second camera 111. It will be understood that the processor 150 may thus be a separate device in embodiments. However, in other embodiments, the processor 150 may be provided as part of one or both of the liquid lens 125 and/or the camera 110. For example, in an embodiment, the processor 150 may be a controller of one or both of the camera 110 and/or the liquid lens 125 or may be a part of such a controller. Still further, the processor 150 may be formed by or included in control devices of one or both of these components. Still further, in embodiments, the processor 150 may be connected to the laser 120 and/or to other components of the system 100, including, for example, the second camera 111 as shown in FIG. 1B. For example, the processor 150 may control one or more of the components of the optical system 100. Still further, the processor 150 may be a system controller of the system 100 or may be included in such a system controller.

In embodiments, the optical system 100 (or sensor system) uses the camera 110 at one end and the laser 120 at the other end. The laser 120 can provide a spot laser and/or a line laser. For example, in the schematic embodiment of FIGS. 1A and 1B, the laser 120 may provide a laser line that is oriented such that it extends upward from the page, i.e., out of the page, at positions a2, b2, and c2.

A field of view of the camera 110 overlaps the spot laser and/or line laser, and is separated therefrom by a triangulation angle. For example, the camera 110 may be focused on the spot laser and/or line laser.

Still further, in some embodiments, the second camera 111 may be provided on the opposite side of the laser 120 as shown in FIG. 1B. The second camera may provide a known position as part of a triangulation process to accurately and reliably determine the position of the laser spot or laser line as discussed above.

Referring still to FIGS. 1A and 1B, the liquid lens 125 is placed into a beam path of the laser 120. The liquid lens 120 and camera 110 are synchronized, for example, through an electronic signal, which could originate at either the lens driver, the camera 110, the processor 150, or an external source. When the camera 110 begins collecting light, the liquid lens 125 drives the laser waist to the location that the camera 110 is currently imaging. As the rolling shutter of the camera 110 moves, the liquid lens 125 adjusts to keep the laser waist in the active area of the rolling shutter. This produces an image with a smallest possible laser spot throughout the entire field of view of the camera 110. This synchronization between the liquid lens 125 and the camera 110 is discussed in more detail below.

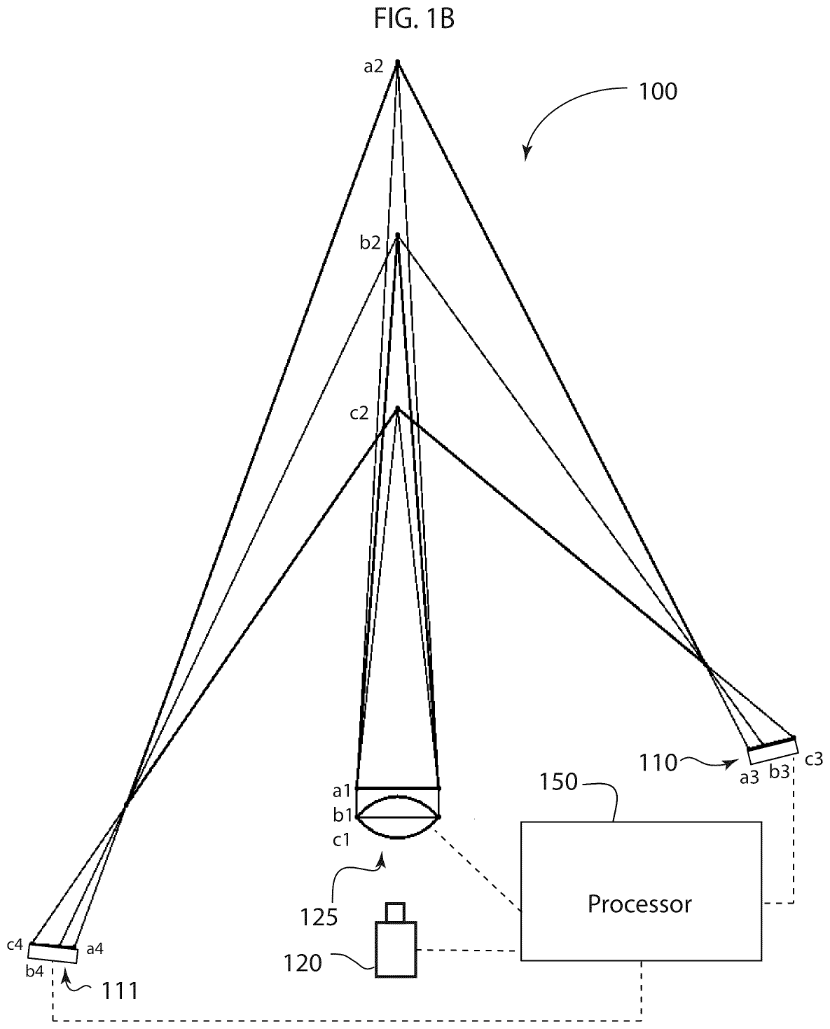

FIG. 2 schematically depicts another configuration of an optical system 200 taking advantage of a Scheimpflug configuration. The optical system 200 is depicted with the same components as optical system 100 and teachings from one system/figure may be applied equally to the other system/figure.

In this Scheimpflug configuration an image plane (of the camera 110) is tilted relative to the lens, for example, liquid lens 125; thus, an object plane is also tilted. As a result, the object plane may overlap with the laser beam, for example, through an entire length. This configuration allows for a smaller triangulation angle while keeping the laser beam in best focus for the camera 120. For example, focus can be improved even without moving parts on receiving optics.

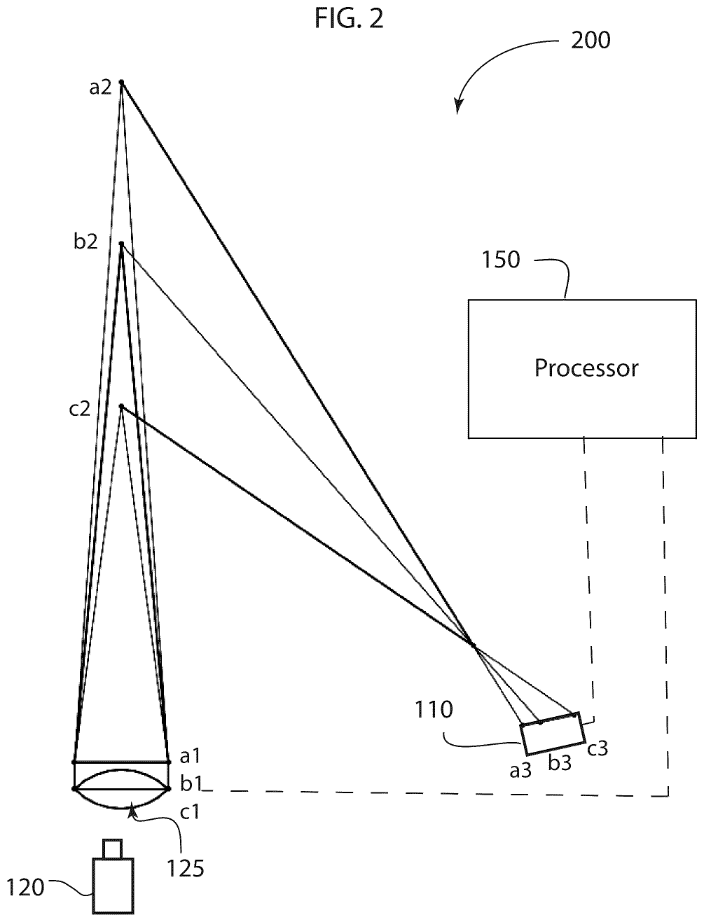

FIG. 3 depicts a general schematic of a Scheimpflug configuration, for example, a Scheimpflug line laser system 300. A line laser generator sits at 320, passes through a liquid lens at 325 forming a laser plane 321. A camera field of view observes the laser plane, for example, in region 319 which is collected by a lens 311. A camera 310, for example, a rolling shutter camera, is synchronized with the liquid lens 325, and oriented at a Scheimpflug angle to keep the laser plane 321 and camera focus plane aligned. In embodiments, the camera 310 is oriented to have a slow sweeping direction of pixel readout along a direction a laser waist of a laser line of the line laser generator 320 will move.

Referring back to FIG. 2, as in FIGS. 1A and 1B, the liquid lens 125 of FIG. 2 is again shown in three different settings and respective times, for example, a1, b1 and c1. These settings lead to respective laser beam waist points of the laser beam emitted by the laser 120, for example, at a2, b2 and c2. Further, the respective times correspond to when the camera 110 is gathering light at positions a3, b3 and c3 respectively, as discussed in more detail above with respect to FIGS. 1A and 1B.

Again, the liquid lens 125, or settings thereof, may be altered to provide a laser beam waist of the laser beam emitted by the laser 120 substantially at the respective location currently being imaged by the camera 110, for example, a region of interest being imaged by the camera 110 or a location being imaged by the camera 110 as the camera proceeds through an imaging sequence, along pixel row(s), or the like.

Like in the system 100 of FIGS. 1A and 1B, in system 200 of FIG. 2, the liquid lens 125, or the settings thereof, may be synchronized to the camera 110, for example, using the processor 150.

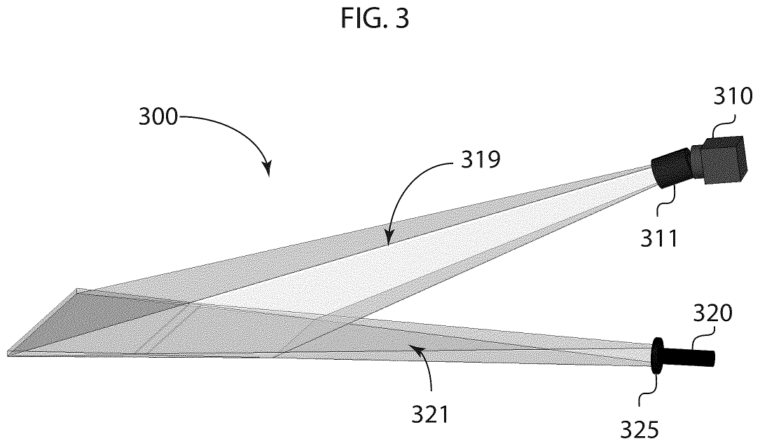

FIG. 4 depicts a comparison of pixel collection for a rolling shutter camera compared to a global shutter camera. With each square representing a single pixel, the global shutter exposes all pixels on an imager at once, resulting in an image of an instance in time. A rolling shutter allows for pixels to be exposed one row at a time, starting at one end of the imager and revealing more rows consecutively over the duration of its exposure time.

In embodiments, when the rolling shutter camera, such as camera 110, is synchronized with a liquid lens, such as liquid lens 125, the collected image of a laser line, for example, from laser 120, may be optimized to ensure time and location of best focus for a respective pixel or pixel row. Likewise, in embodiments, when the global shutter camera, such as camera 110, is synchronized with a liquid lens, such as liquid lens 125, the collected image of a laser line, for example, from laser 120, may be optimized to ensure time and location of best focus for a respective region of interest.

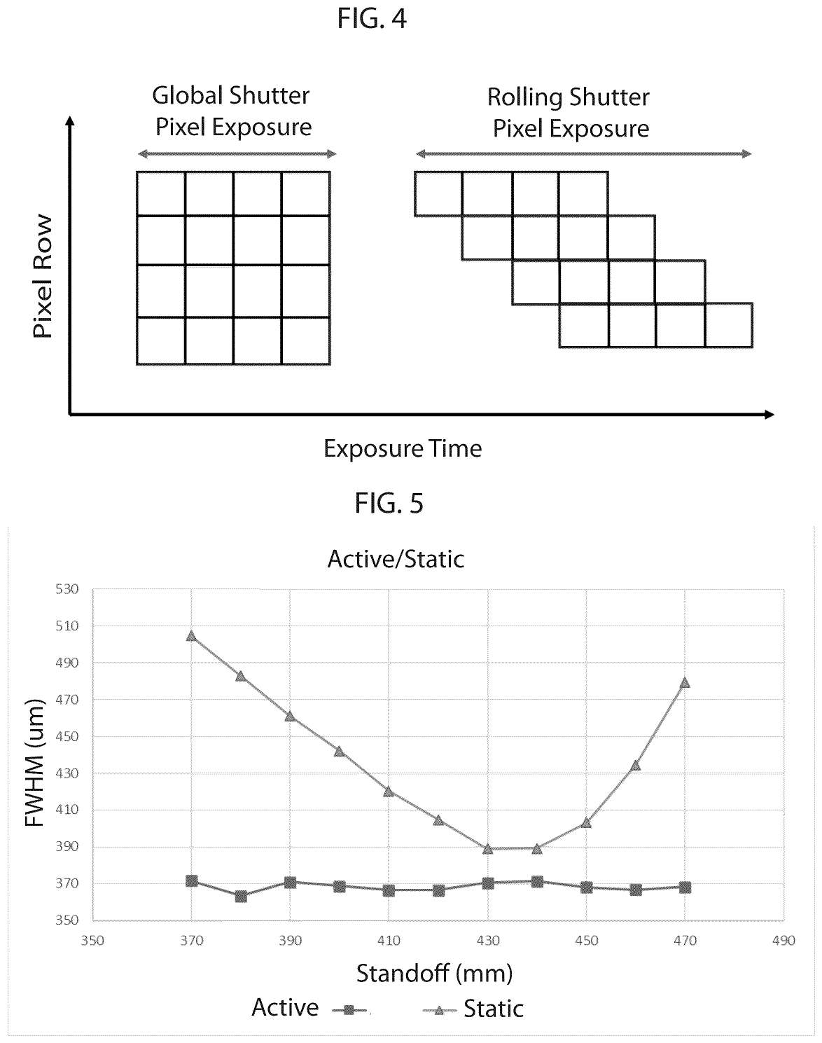

FIG. 5 is a graph of comparative data gathered using optical systems with and without synchronizing according to embodiments, also referred to as “active” and “static.”

The non-synchronized or static approach does not synchronize the lens; instead, the lens is set to a single best focus. For example, the single best focus may be predicted by the gaussian wave equation. The apparent laser width is depicted. As shown, the apparent width varies significantly as a standoff distance changes.

The synchronized or active approach uses a liquid lens synchronized to the camera according to embodiments as discussed above. As shown, this approach yields a smaller laser width and is significantly more consistent across different standoff values. Thus, even as the standoff distance changes, a more precise laser spot/laser line is provided at the imaged location.

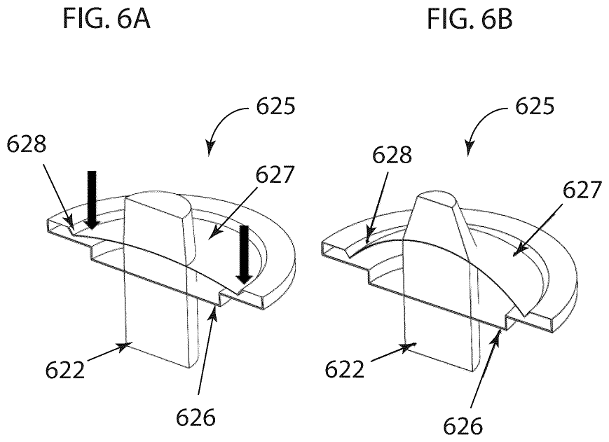

FIGS. 6A and 6B depict models of a liquid lens 625 according to embodiments. The liquid lens 625 interacts with a laser beam 622. The liquid lens 625 may comprise a container 626 filled with an optical fluid. Further, the liquid lens 625 may comprise a membrane 627 and an actuator 628. In embodiments, the actuator 628 may comprise a voice coil.

The actuator 628 may be part of the lens driver discussed above and may be used to drive the lens, i.e., alter the lens. For example, when a current is applied to the voice coil, the actuator 628 exerts a force on the membrane 627. For example, in embodiments the voice coil converts an electrical signal into a mechanical force. The force on the membrane 627 results in a changed profile of the membrane 627, for example, a bulge whose radius varies depending on the applied current. As shown in FIG. 6B compared with FIG. 6A, a change in applied current results in a changed profile, i.e., a greater bulge, of the membrane 627. A corresponding change in the laser beam 622 is also depicted. As schematically shown, a greater bulge in the profile of the membrane results in an increase in optical power which brings the laser waist closer to the exit window of the liquid lens 622.

In embodiments, the design of the liquid lens 625 reflects performance of a plano-convex lens with one end having a flat surface, for example, the container 626 in embodiments, and another end having a radius greater than zero, for example, the membrane 627 in embodiments. Such a design allows for a linear relationship between a focal length of the liquid lens 625 and its radius, making the applied current and focal length of the liquid lens 625 proportional to one another. For example, the relationship between the radius of the membrane 627 and the focal length of the liquid lens 625 may be determined by the Lens Maker's equation.

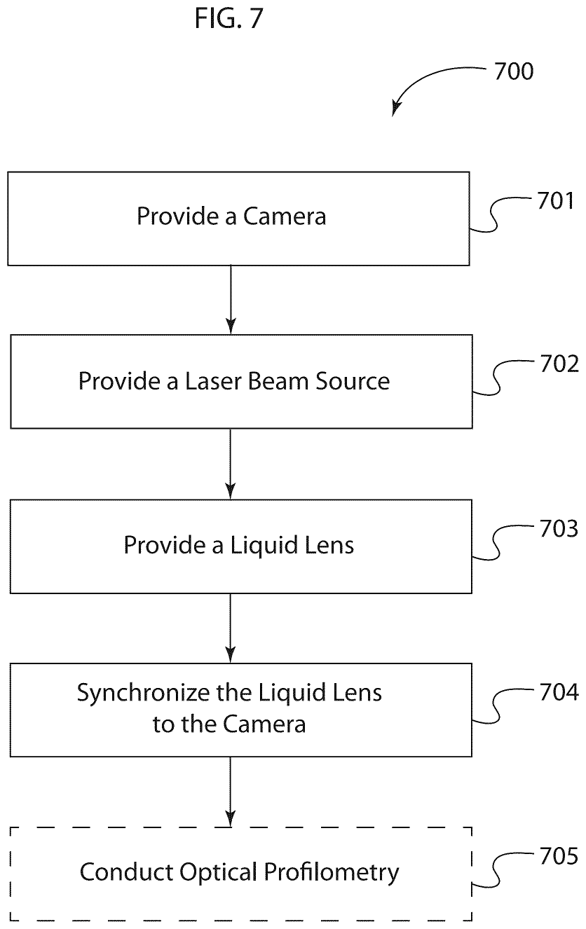

FIG. 7 shows a method 700 according to embodiments. In step 701 a camera, such as camera 110, is provided. As discussed above, the camera may be a rolling shutter camera or a global shutter camera. In step 702 a laser beam source, for example, such as laser 120, is provided. In step 703 a liquid lens, such as liquid lens 125, is provided. In step 704 the liquid lens is synchronized to the camera. For example, the liquid lens may be synchronized to the camera using a variety of methods as discussed above. Synchronizing the liquid lens may include changing a shape or profile of the liquid lens, for example, changing the profile of a bulge of a membrane such as membrane 627. Likewise, synchronizing the liquid lens may include changing or moving a laser beam waist of a laser provided by the laser source. As discussed in more detail above, synchronizing the liquid lens to the camera may comprise altering the liquid lens to move a laser beam waist to correspond with an imaged pixel or pixel row of a rolling shutter of the camera and/or an imaged region of interest of the camera.

In embodiments, the method 700 may include optional step 705 wherein optical profilometry is conducted using the synchronized liquid lens.

Synchronization between the camera and liquid lens can be achieved in several ways. For example, in embodiments, profiles for the liquid lens, or the membrane thereof, can be derived empirically through testing a laser focus at various locations in a camera's field of view. This testing can be performed in advance of conducting optical profilometry with the system or during such a process. For example, combining the derived profiles with a pixel readout timing on the rolling shutter camera, a single sweep profile can be derived and used repeatedly regardless of target configuration. In such embodiments, triggering the start of the liquid lens profile and the start of the frame simultaneously must still be accomplished. One approach according to embodiments is to have a flash signal from the camera used to signal the start of the liquid lens profile. Another approach according to embodiments is to have the liquid lens driver output a digital signal on a transistor transistor logic line, which was used as a trigger to start the camera frame. A still further approach according to embodiments is to use an independent signal sent to both the camera and lens driver.

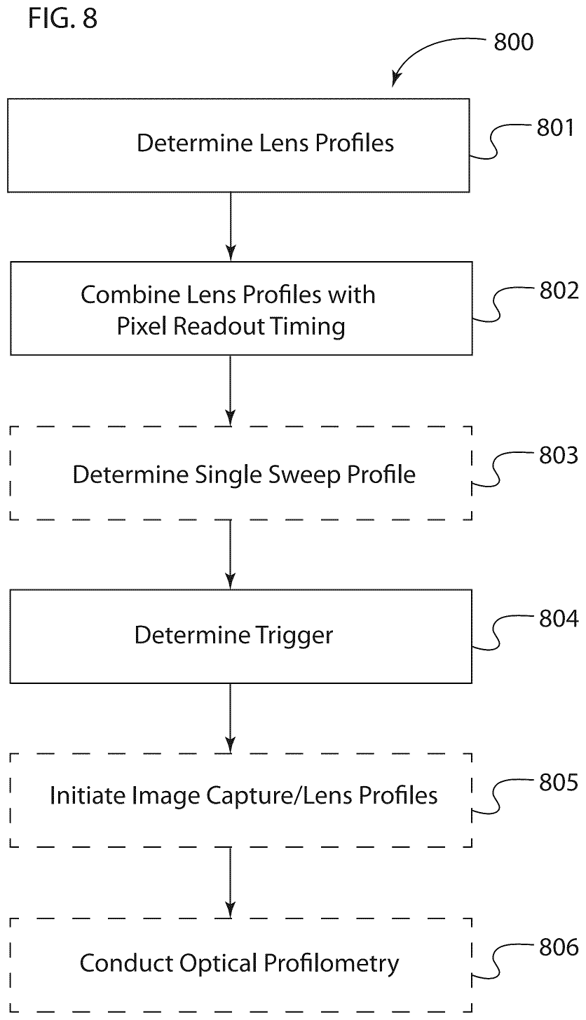

FIG. 8 shows a method 800 for synchronizing a liquid lens to a camera, for example, a rolling shutter camera, according to embodiments. In step 801, lens profiles are determined, for example, as discussed above. In step 802, the determined lens profiles are combined with pixel readout timing on the camera. As discussed above, this can allow for a single sweep profile to be determined, as shown in optional step 803. In step 804, a trigger for one or both of the liquid lens and the camera is determined. In embodiments, the method 800 may include optional step 805 comprising initiation of image capture, the determined lens profiles, or both. Likewise, in embodiments, the method 800 may include optional 806 wherein optical profilometry is conducted, for example, using the determined lens profiles.

In embodiments, the steps or functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. Still further, in embodiments, steps may be omitted and/or additional steps may be included. Moreover, steps or functions from different Figures may be combined and/or applied to one another.

The synchronization between the camera and the liquid lens can be achieved through a series of calculations based on known values. In embodiments, these calculations may need to determine the following relationships: laser beam waist location with respect to time, focal length of the liquid lens with respect to laser beam waist location, focal length of the liquid lens with respect to applied current, and applied current with respect to time. In embodiments, beam waist location with respect to time can be determined using optics simulation software that models the relationship between object space and image space. For example, a model of the optical system using the known field of view, liquid lens properties, camera properties, and Scheimpflug configuration of the camera lens may be built. From the model a correlation between object space, where the beam is physically located in the optical system, and image space, where the beam would fall on the camera's 2D array may be developed.

The locations in image space provided by the simulation can be converted to units of time by utilizing camera specifications such as pixel dimensions and frame rate. These values may then be graphed with respect to the corresponding locations in object space to develop an equation that is representative of the relationship between beam waist location and time. An example of this relation is shown in Equation 1, where t is time in units of seconds and x is the object distance in units of millimeters. Without the Scheimpflug configuration, Equation 1 would be a linear relationship.

$$x = 10 , 340.9 {t}^{2} - 2201.02 t + 410.00493 \qquad Equation l$$

Using simulation generated values of potential beam waist locations in object space of the optical system, it is possible to determine the focal length that the liquid lens would need in order to place the beam waist at those locations. In the thin lens equation, shown as Equation 2, focal length, object distance and image distance are represented by f, O and/respectively.

$$dpt = \frac{1}{f} = \frac{1}{Object} + \frac{1}{Image} \qquad Equation 2$$

Equation 2 is used to find the object distance by setting the focal length equal to that of the laser's interior optics, for example 0.004 m, and the image distance as the uncompensated standoff of the optical system, for example 610 mm. Using these example values would result in an object distance of 4.0264026 mm. Keeping the object distance constant, a range of diopter values can be plugged into Equation 2 to generate a series of values for focal length and image distance from which their relation can be derived. An example of this derived relation is shown in Equation 3, where x is object distance (i.e. beam waist location) and dpt is the lens focal length in diopters.

$$dpt = 9.18856 \times 1 {0}^{- 6} {x}^{2} - 0.0126963 x + 4.20424 \qquad Equation 3$$

The properties of the liquid lens provided by the manufacturer are referenced to obtain Equation 4, which related focal length in diopters, dpt, to applied current, i. This relation can also be determined empirically by applying a known current value to the liquid lens and measuring the resulting focal length.

$$dpt = 0.0238100 i - 1.90476 \qquad Equation 4$$

Using Equations 1, 3 and 4, the relationship between applied current and time can be derived resulting in Equation 5.

$$I = 41 , 267.2 {t}^{4} - 50 , 29.9 {t}^{3} - 372.196 {t}^{2} + 477.144 t + 102.817 \qquad Equation 5$$

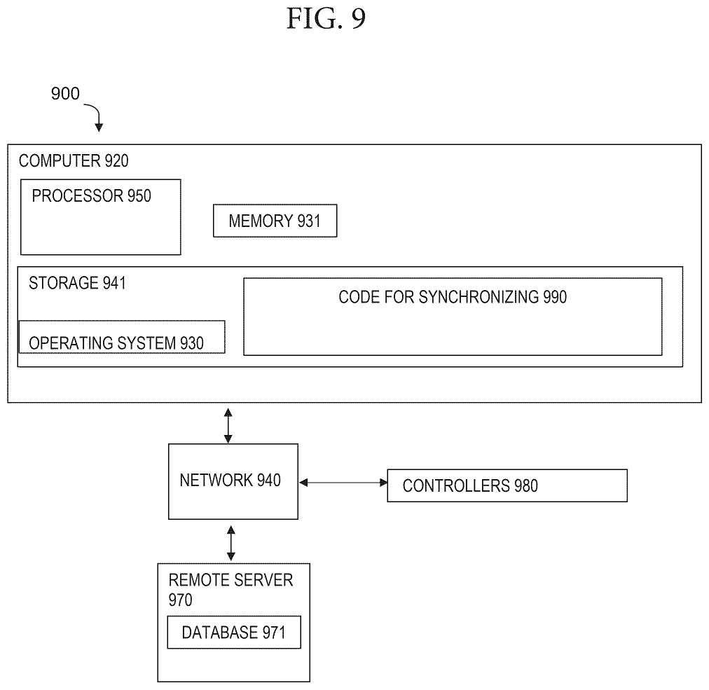

As discussed above, in embodiments, the synchronization may be accomplished using a processor, such as the processor 150 shown in FIGS. 1A, 1B, and 2. FIG. 9 depicts a computing environment which contains an example of an environment for the execution of at least some of the computer code involved in performing the inventive methods, in accordance with embodiments of the present invention. Computing environment 900 contains an example of an environment for the execution of at least some of the computer code involved in performing the inventive methods, such as code 990 for synchronizing a liquid lens to a camera. Computing environment 900 includes, for example, computer 920, network 940, such as a wide area network (WAN), controllers 980, and remote server 970 with database 971. Computer 920 includes processor 950, memory 931, storage 941 (including operating system 930 and code 990). The computer 920 is connected to the remote server 970 and the controllers 980, for example, over the network 940, directly, or otherwise.

Code 990 may include instructions or modules for performing synchronization as discussed above. For example, in embodiments, code 990 may include instructions or modules for determining lens profiles, combining the determined lens profiles with pixel readout timing of the rolling shutter camera, determining a trigger for one or both of the liquid lens and the rolling shutter camera, initiating image capture, the determined lens profiles, or both, conducting optical profilometry, and the like.

In embodiments, a computer program product (non-transitory computer readable storage medium having instructions, which when executed by a processor, perform actions) is provided. For example, the computer program product may comprise a computer usable storage medium having program instructions embodied therewith, the program instructions readable by one or more processors of a computer system to cause the one or more processors to: synchronize a liquid lens to a camera and/or to perform synchronized optical profilometry.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Cloud computing environment includes one or more cloud computing nodes with which local computing devices used by cloud consumers, such as, for example, personal digital assistant (PDA) or cellular telephone, desktop computer, laptop computer, etc. Nodes may communicate with one another. They may be grouped (not shown) physically or virtually, in one or more networks, such as Private, Community, Public, or Hybrid clouds as described hereinabove, or a combination thereof. This allows cloud computing environment to offer infrastructure, platforms and/or software as services for which a cloud consumer does not need to maintain resources on a local computing device. It is understood that the types of computing devices are intended to be illustrative only and that computing nodes and cloud computing environment can communicate with any type of computerized device over any type of network and/or network addressable connection (e.g., using a web browser).

A cloud computing environment includes a set of functional abstraction layers. The following layers and corresponding functions are provided:

Hardware and software layer includes hardware and software components. Examples of hardware components include: mainframes; RISC (Reduced Instruction Set Computer) architecture based servers; servers; blade servers; storage devices; and networks and networking components. In some embodiments, software components include network application server software and database software.

Virtualization layer provides an abstraction layer from which the following examples of virtual entities may be provided: virtual servers; virtual storage; virtual networks, including virtual private networks; virtual applications and operating systems; and virtual clients.

In one example, management layer may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer provides examples of functionality for which the cloud computing environment may be utilized. Examples of workloads and functions which may be provided from this layer include: mapping and navigation; software development and lifecycle management; virtual classroom education delivery; data analytics processing; transaction processing; synchronization, and/or profilometry.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

An exemplary use case for embodiments is measuring corners using an optical profilometer sensor system, such as system 100 or system 200, and/or using methods such as method 700 or method 800. An exemplary laser, such as laser 120, may be a 450 nm laser using a divergence angle of 0.7 mrad and making a 400 μm line with a Rayleigh range of 280 mm. This works well for a static laser for a sensor system with a similar depth of field, around 200 mm. With a camera, such as camera 110, with 3000 pixels, this spreads the laser line over approximately 6 pixels. Moving to a higher resolution camera, with twice as many pixels, a better suited laser line would be 200 μm wide, with a divergence angle of 1.4 mrad. However, this will yield a much wider beam in the near and far field, with an apparent intensity ratio of almost 2:1 for a line laser.

Systems and methods according to embodiments of the invention will allow for the smaller, 200 μm wide, beam throughout the entire field of view of the camera. System accuracy is often dependent on laser line width and effective pixel size. This would allow a system operating with a 50 μm repeatability to achieve a 30 μm repeatability, assuming no limitations due to mechanical stability or other factors.

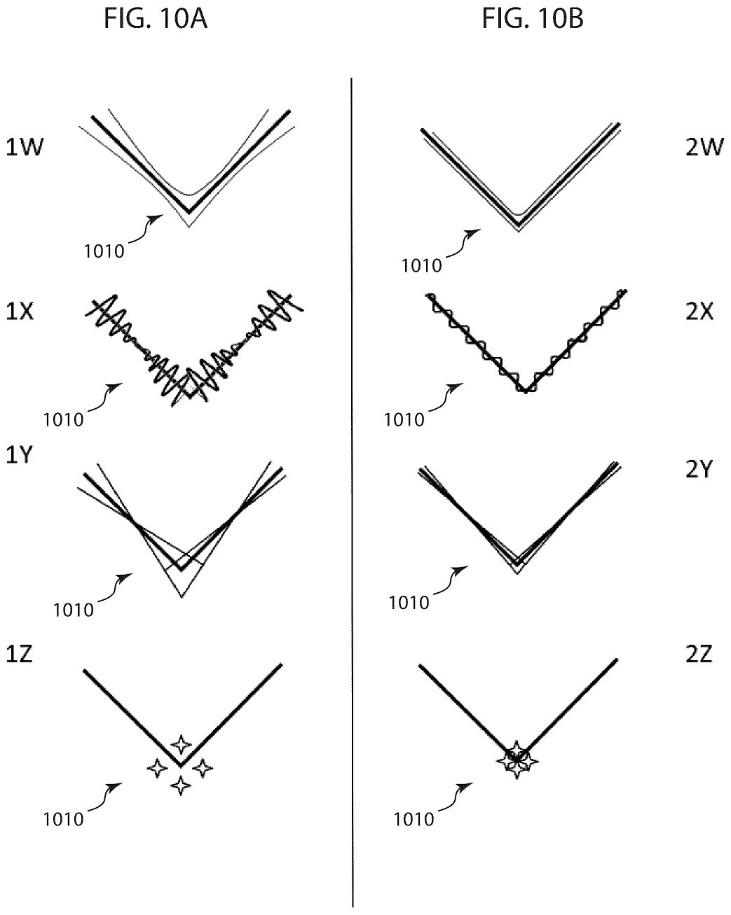

Systems using the embodiments described herein, for example, a liquid lens in front of a laser and synchronized to a camera, may provide improved measurement of a corner compared with conventional systems. FIGS. 10A and 10B depict measurement of a corner 1010 and such improved measurement. FIG. 10A depicts conventional measurement, i.e., measurement without using the embodiments described herein. FIG. 10B depicts measurement using the embodiments described herein and shows exemplary improvement realized by embodiments. As shown, corner measurement is performed by evaluating the light intensity on the collected image of the corner 1010 and determining the center of the range of intensities. In an optical system not using embodiments, for example, a system that does not use a synchronized liquid lens as described herein, the laser covers the corner with a beam whose thickness is dependent on the location of the corner from the exit window of the laser as shown in FIG. 10A. Using an approach that relies on a calculation of the laser line center to locate and measure the location of a corner, a thick beam, shown in 1W, would result in more data to contribute to this calculation, as shown by 1X, and thus a higher range of error when applying a linear fit to the data, 1Y, and determining the corner location, 1Z. Contrarily, as shown in FIG. 10B, when using embodiments described herein, for example, optical systems having a synchronized liquid lens, the laser waist can be placed at the distance of the measurement location from the exit window of the liquid lens. This projects a thin and consistent laser line onto the corner as shown in 2W, allowing the calculation to rely on a much smaller data set, shown by 2X, decreasing the error in the applied linear fit, 2Y, and more precise measurement of the corner location, 2Z. Accordingly, improved and more precise measurement of the corner 1010 may be achieved.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An optical sensor system comprising:
a rolling shutter camera;
a laser; and
a liquid lens placed in a path of the laser;
wherein the liquid lens is synchronized to the rolling shutter camera.

2. The optical sensor system of claim 1, wherein the liquid lens is synchronized to a rolling shutter of the rolling shutter camera.

3. The optical sensor system of claim 1, wherein the liquid lens has a drive system for changing a shape of the liquid lens.

4. The optical sensor system of claim 3, wherein the drive system is tuned to a field of view of the camera.

5. The optical sensor system of claim 1, wherein the liquid lens drives a laser waist to a position in a field of view of the camera.

6. The optical sensor system of claim 1, wherein the liquid lens is driven so that a narrowest part of a laser beam is imaged by the camera.

7. The optical sensor system of claim 1, wherein the liquid lens comprises an actuator and a membrane.

8. The optical sensor system of claim 1, wherein the liquid lens comprises voice coil.

9. The optical sensor system of claim 1, wherein the optical sensor system is an optical profilometer sensor.

10. The optical sensor system of claim 1, wherein a Scheimpflug configuration is used.

11. A method for synchronized optical profilometry, comprising:
providing a camera;
providing a laser beam source;
providing a liquid lens; and
synchronizing the liquid lens to the camera.

12. The method of claim 11, wherein the camera is a rolling shutter camera.

13. The method of claim 11, wherein synchronizing the liquid lens includes altering a profile of a membrane of the liquid lens.

14. The method of claim 11, wherein synchronizing the liquid lens includes moving a laser beam waist.

15. The method of claim 11, wherein the laser beam waist is moved to correspond with a rolling shutter of the camera.

16. The method of claim 11, further comprising conducting optical profilometry using the synchronized liquid lens.

17. The method of claim 11, wherein synchronizing the liquid lens to the camera includes determining lens profiles, and combining the lens profiles with a pixel readout timing of the camera.

18. The method of claim 17, wherein synchronizing the liquid lens further includes determining a single sweep profile.

19. A computer program product comprising a computer readable hardware storage medium having program instructions embodied therewith, the program instructions readable by one or more processors of a computer system to cause the one or more processors to: synchronize a liquid lens to a rolling shutter camera.
